(19) United States
(12) Patent Application Publication
(10) Pub. No.: US 2008/0170121 A1
(43) Pub. Date: Jul. 17, 2008

(54) Vandal-Proof Rack Structure for Surveillance Monitors

(75) Inventors: Chen-Shun Su, Keelung City (TW); Chun-I Huang, Taipei City (TW)

Correspondence Address: WPAT, PC, 7225 BEVERLY ST., ANNANDALE, VA, 22003, US

(73) Assignee: CWELL VISION CORPORATION, Taipei (TW)

(21) Appl. No.: 11/622,888

(22) Filed: Jan. 12, 2007

(51) Int. Cl. H04N 7/18

(52) U.S. Cl. 348/143; 348/E07.085

(57) ABSTRACT

A vandal-proof rack structure for a surveillance monitor is disclosed, which comprises: a frame, having a first gear positioned at a specific location thereof and being used for receiving the surveillance monitor; a first axial seat, having a second gear and a third gear arranged thereat while enabling the second gear to mesh with the first gear and thus enabling the frame to pitch vertically with respect to the first axial seat; and a second axial seat, having a fourth gear arranged thereon while enabling the fourth gear to mesh with the third gear and thus enabling the first axial seat to yaw horizontally with respect to the second axial seat.

### FIELD OF THE INVENTION

The present invention relates to a vandal-proof rack structure for surveillance monitors, and more particularly, to a monitor rack capable of enabling its monitoring direction to be secured fixedly by the adjustment of gears fitted therein as the gears can be enabled to mesh tightly with each other for providing a comparatively large resistance after a specific monitoring angle is achieved by the adjustment, so that it can satisfy a need for better crime prevention since it is difficult to be damaged or deflected from its original monitoring direction when being pounded or rammed deliberately.

### BACKGROUND OF THE INVENTION

By far, the most common threat to our home is burglary and theft. Becoming a burglary victim can leave a family feeling vulnerable and violated. To avoid becoming a burglary victim, most people choose to install a security system of surveillance monitors as protection. It is considered that security systems definitely can effectively deter burglaries and thefts because they increase the potential and fear of being caught and arrested by the police. The deterrent value comes from the full-scope monitoring/recording capability of the surveillance monitors.

However, as soon as a surveillance monitor is spotted, the instinct of a common burglar or thief is to tamper the surveillance monitor for defecting the monitoring direction away from the crime scene, or even simply to break it. Since most surveillance monitor is not designed with any vandal-proof mechanism, the aforesaid tampering can be achieved easily.

Therefore, it is in need of a vandal-proof rack structure for surveillance monitors that is free from the aforesaid shortcoming.

### SUMMARY OF THE INVENTION

In view of the disadvantages of prior art, the primary object of the present invention is to provide a vandal-proof rack structure for surveillance monitors capable of enabling its monitoring direction to be secured fixedly by the adjustment of gears fitted therein as the gears can be enabled to mesh tightly with each other for providing a comparatively large resistance after a specific monitoring angle is achieved by the adjustment, so that it can satisfy a need for better crime prevention since it is difficult to be damaged or deflected from its original monitoring direction when being pounded or rammed deliberately.

It is another object of the invention to provide a vandal-proof rack structure for a surveillance monitor, having a frame, a first and second axial seats being securely fixed upon each other by gears formed therein while enabling the monitoring angle of the surveillance monitor to be adjustable by adjusting the inter-meshed gears and further securing the monitoring angle to a predetermined angle without being deflected by external force by enabling the gears to mesh tightly with each other.

To achieve the above objects, the present invention provides a vandal-proof rack structure for a surveillance monitor, comprising:
a frame, having a first gear positioned at a specific location thereof and being used for receiving the surveillance monitor;
a first axial seat, having a second gear and a third gear arranged thereat while enabling the second gear to mesh with the first gear and thus enabling the frame to pitch vertically with respect to the first axial seat; and
a second axial seat, having a fourth gear arranged thereon while enabling the fourth gear to mesh with the third gear and thus enabling the first axial seat to yaw horizontally with respect to the second axial seat.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an exploded view of a vandal-proof rack structure for a surveillance monitor according to the present invention.

FIG. 2 is a schematic view of a vandal-proof rack structure for a surveillance monitor according to the present invention

FIG. 3 shows the assembling of a first axial seat to a second axial seat according to a first preferred embodiment of the invention.

FIG. 4 shows the assembling of a first axial seat to a second axial seat according to a second preferred embodiment of the invention.

FIG. 5 shows the assembling of a frame to an assembly of a first and a second axial seats according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

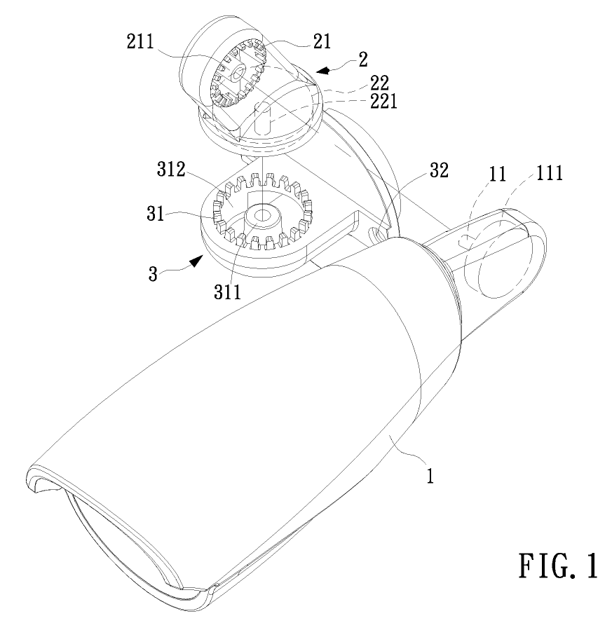

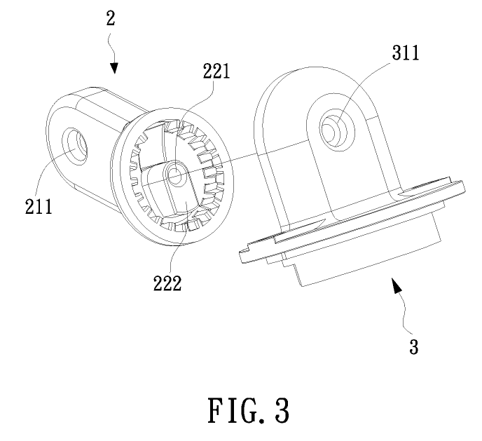

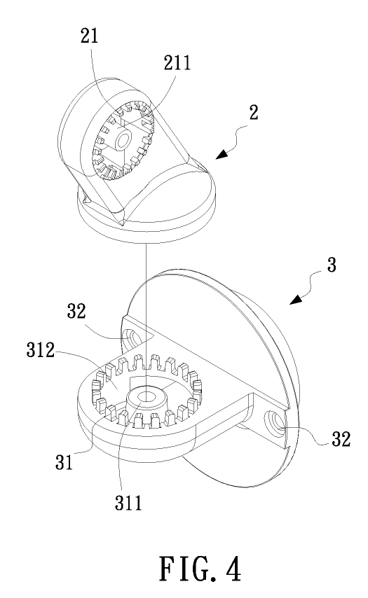

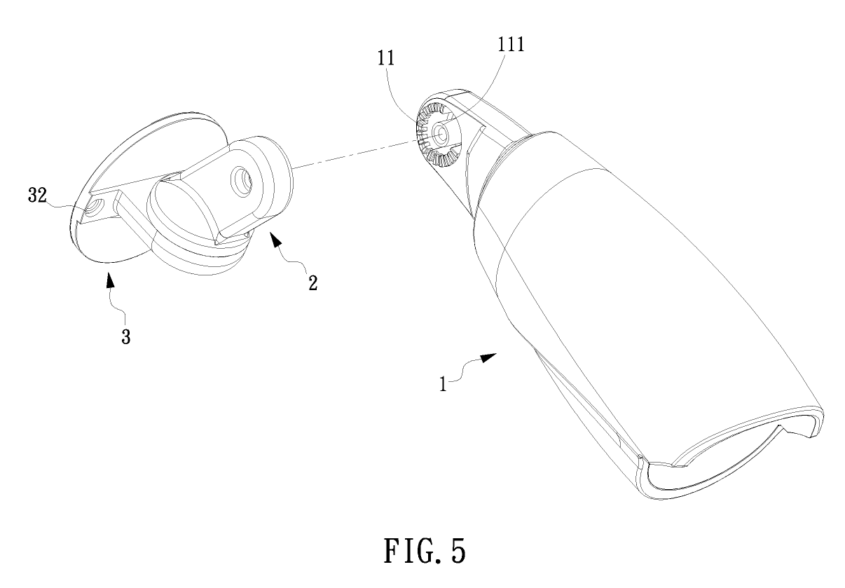

Please refer to FIGS. 1, 3, 4, and 5, which shows a vandal-proof rack structure for a surveillance monitor according to the present invention. The frame 1 of the rack structure is shaped as a telescope, which has a monitor (not shown in the figures) received therein. It is noted that the monitor is composed of a CCD, a lens and relating components which are known to those skilled in the art and thus are not described further herein. Moreover, a flat platform, having a first gear disposed at a side thereof, is extending from the rear of the frame 1 while enabling the first gear to mesh with a second gear 21 disposed on a first axial seat 2 and thus enabling the frame 1 to pitch vertically with respect to the first axial seat 2. In a preferred aspect, the first and the second gears are fixedly secured to the frame 1 and the first axial seat 2 respectively by a holding part (not shown in the figures), whereas the holding part can be a screw or a bolt. In addition, a third gear 22 is arranged on the first axial seat 2 at a surface perpendicular to that of the second gear 21 while enabling a fourth gear 31 of a second axial seat 3 to mesh with the third gear 22 and thus enabling the first axial seat 2 to yaw horizontally with respect to the second axial seat 3. Similarly, the third and the fourth gears are fixedly secured to the first axial seat 2 and the second axial seat 3 respectively by a holding part (not shown in the figures), whereas the holding part can be a screw or a bolt. Moreover, the third gear 22 further comprises: a positioning block, capable of being wedged and fitted into a recess 321 formed on the four gear 31 so as to secure the relative positioning of the first and the second axial seats 2, 3. Furthermore, at least a pin hole 32 is formed on the second axial seat 3 for facilitating the surveillance motor to be fixed to a specific location by fixing parts (not shown in the figures) corresponding thereto.

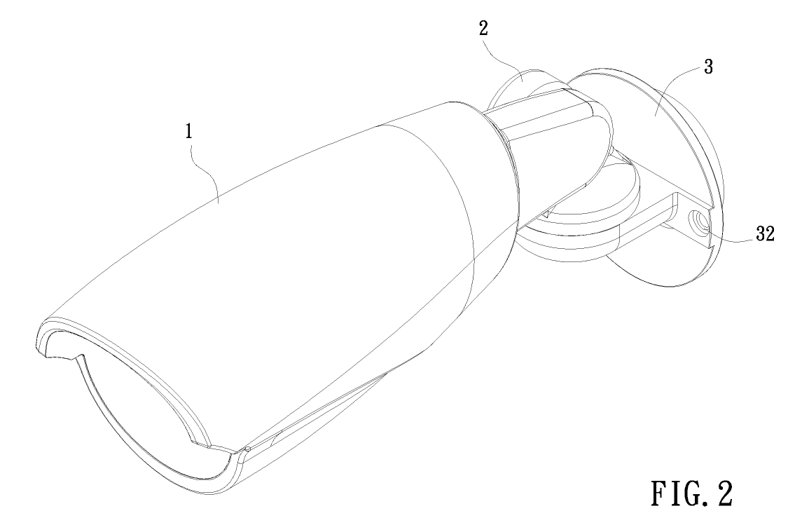

In a preferred embodiment of the invention, each of the first, second, third and fourth gears 11, 21, 22, 31 has an annular flange, respectively as the annular flanges 111, 211, 221 and 311, formed coaxial to the center thereof for allowing the corresponding holding part to piece therethrough, whereas the holding part can be a screw or a bolt. The resulting assembly of aforesaid components is shown in FIG. 2.

From the above description, a vandal-proof rack structure for surveillance monitors is achieved, which is capable of enabling its monitoring direction to be secured fixedly by the adjustment of gears fitted therein as the gears can be enabled to mesh tightly with each other for providing a comparatively large resistance after a specific monitoring angle is achieved by the adjustment, so that it can satisfy a need for better crime prevention since it is difficult to be damaged or deflected from its original monitoring direction when being pounded or rammed deliberately. Moreover, by the inter-meshing gears of the frame, the first and the second axial seats, the monitoring angle of the surveillance monitor can be adjusted by adjusting the inter-meshing gears and thus the monitoring angle can be further secured to a predetermined angle without being deflected by external force by enabling the gears to mesh tightly with each other. It is noted that the vandal-proof rack structure can also be used for supporting a close circuit TV system.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A vandal-proof rack structure for a surveillance monitor, comprising:
a frame, having a first gear positioned at a specific location thereof and being used for receiving the surveillance monitor;
a first axial seat, having a second gear and a third gear arranged thereat while enabling the second gear to mesh with the first gear and thus enabling the frame to pitch vertically with respect to the first axial seat; and
a second axial seat, having a fourth gear arranged thereon while enabling the fourth gear to mesh with the third gear and thus enabling the first axial seat to yaw horizontally with respect to the second axial seat.

2. The vandal-proof rack structure of claim 1, wherein the third gear further comprises: a positioning block, capable of being wedged and fitted into a recess formed on the four gear so as to secure the relative positioning of the first and the second axial seats.

3. The vandal-proof rack structure of claim 1, wherein the first and the second gears are fixedly secured to the frame and the first axial seat respectively by a holding part.

4. The vandal-proof rack structure of claim 3, wherein the holding part is a component selected from the group consisting of a screw and a bolt.

5. The vandal-proof rack structure of claim 1, wherein the third and the fourth gears are fixedly secured to the first axial seat and the second axial seat respectively by a holding part.

6. The vandal-proof rack structure of claim 5, wherein the holding part is a component selected from the group consisting of a screw and a bolt.

7. The vandal-proof rack structure of claim 1, wherein each of the first, second, third and fourth gears has an annular flange formed coaxial to the center thereof for allowing the corresponding holding part to piece therethrough.

8. The vandal-proof rack structure of claim 1, wherein at least a pin hole is formed on the second axial seat for facilitating the surveillance motor to be fixed to a specific location by fixing parts corresponding thereto.

9. The vandal-proof rack structure of claim 8, wherein the fixing part is a component selected from the group consisting of a screw and a bolt.
